(19) United States
(12) Patent Application Publication
(10) Pub. No.: US 2010/0104762 A1
(43) Pub. Date: Apr. 29, 2010

(54) METHOD FOR MANUFACTURING A FLEXIBLE AND BREATHABLE MATT FINISH GLOVE

(75) Inventors: Mikhail Kassam, Toronto (CA); Akil Jaffer, Markham (CA)

Correspondence Address: OBLON, SPIVAK, MCCLELLAND MAIER & NEUSTADT, L.L.P., 1940 DUKE STREET, ALEXANDRIA, VA, 22314, US

(73) Assignee: MIDAS SAFETY INC., Toronto (CA)

(21) Appl. No.: 12/259,656

(22) Filed: Oct. 28, 2008

(51) Int. Cl. B05D 3/10

(52) U.S. Cl. 427/337

(57) ABSTRACT

A method to prepare a flexible and breathable protective glove having good grip in both aqueous and oil environments includes coating an electrolyte treated knitted glove liner substrate with a dispersion of a polymeric material. The resulting semi-gelled polymeric coating which partially penetrates the depth of the knitted glove liner substrate, is treated with a foamed solution of a surfactant, tenside or aerosol solution and the foam treated coating is overcoated with an electrolyte solution. In a resulting chemical or physical reaction, fine pores and cavities are formed in and on the polymer coating.

### BACKGROUND OF THE INVENTION

1. Field of the Invention

The present invention relates to a method for the manufacture of a flexible and breathable matte finish glove.

2. Discussion of the Background

Gloves can provide important protection to the hands in many industrial or household tasks. Often such tasks are performed in fluid environments where not only protection from such materials as water, aqueous solutions of various degrees of alkalinity or acidity, oil, gasoline or similar materials is required, but also an ability to grip and securely hold or maneuver an object is necessary. For such purposes, the gloves should be comfortable, flexible, provide breathability and provide a grip surface capable of secure grip even when exposed to materials having lubricity which would adversely affect an ability to securely grip an object.

Johnson (U.S. Pat. No. 4,589,940) describes methods for preparing slip resistant articles such as work gloves by laminating a foamed material to a substrate. The foamed material may be polyurethane, polyvinyl chloride, acrylonitrile, natural rubber or synthetic rubber and the level of foam is adjusted according to the required degree of abrasion resistance.

Watanabe (U.S. Pat. No. 4,497,072) describes a method for making a porous hand covering by coating a fabric glove base with a foamed rubber or resin and subjecting the foam coated glove base to sufficiently reduced pressure to cause bursting of the foam bubbles to form a coating surface with a plurality of depressions.

Heeter et al. (U.S. Pat. No. 5,322,729) describes a method and apparatus for producing a breathable coated fabric. The method includes coating a fabric substrate with a resin then opening pores in the resin by directing a flow of air through the fabric substrate and resin coating.

Yamashita et al. (U.S. Pat. No. 6,527,990) describes a method to produce a rubber glove by sequentially performing the step of immersing a glove mold in a coagulating synthetic rubber latex containing synthetic rubber in latex form, thermally expandable microcapsules, and a rubber coagulant to form a coagulant-containing synthetic rubber film on the surface of the glove mould; the step of immersing the glove mold in rubber-incorporating latex to form a gelled rubber layer; the step of heating a rubber laminate composed of the synthetic rubber film and the gelled rubber layer to vulcanize the rubber laminate; and the step of turning the vulcanized rubber laminate inside out, and removing it from the glove mold.

Borreani et al. (U.S. 2002/0076503) describes a clothing article such as a glove characterized in that: the textile support receives an[[d]] adherence primer in the form of an aqueous calcium nitrate; the textile support with the adherence primer is subjected, entirely or partially, to a coating based on a foamed aqueous polymer; the foamed aqueous polymer only appears on the support outer part without going through the mesh so as not to produce contact with the corresponding part of the body.

Dillard et al. (U.S. 2004/0221364) describes methods, apparatus, and articles of manufacture for providing a foam glove, including coating a textile shell with a foamed polymeric coating that is supported in part by the surface of the textile shell. Sufficient amount of air is mixed with the base polymer to lower the density of the base polymer to between about 10 to 50% of the original density of the base polymer.

Flather et al. (U.S. 2005/0035493) describes a glove having a textured surface or textured foam coating produced by embedding a layer of discrete particles, such as salt, into a previously formed liquid layer, gelling or curing the layer and dissolving the discrete particles to leave a textured or textured foamed surface.

Thompson et al. (U.S. 2007/0204381) describes a lightweight thin flexible latex glove article having a polymeric latex coating that penetrates the front portion of a knitted liner half way or more through the liner thickness and for at least a portion of the knitted liner, not penetrating the entire thickness. For example, the liner can be knitted using an 18 gauge needle with 70 to 221 denier nylon 66 multi-filament yarn. The polymer latex coating can be 0.75 to 1.25 times the thickness of the knitted liner. The polymer latex coating may be foamed with 5 to 50 vol % air content. Open celled foamed latex coating may be coated with a dispersion of fluorochemical dispersion to prevent liquid permeation into the glove. The process can include steps to gel the latex emulsion at interstices of the yarn to prevent further penetration of the emulsion into the liner.

In view of the foregoing, there is a need in the art for a facile and economical method to manufacture a comfortable, breathable and flexible matte finish glove providing protection from both aqueous and oil environments, and having improved water and oil grip.

### SUMMARY OF THE INVENTION

One object of the present invention is to provide a method for the manufacture of a matte finish glove with improved water and oil grip that is both flexible and breathable.

A further object of the present invention is to provide such a method that produces a glove having a spongy and permeable coating which allows a desired dexterity.

These and other objects of the present invention, either individually or in combinations thereof, have been satisfied by the discovery of a method for preparing a flexible, liquid absorbent coated glove, comprising:

treating a knitted glove liner fitted onto a glove mould with a nonionic softener;

coating the treated knitted glove liner fitted onto a glove mould, with a foamed or non-foamed electrolyte solution;

drying the coated glove liner fitted onto a glove mould;

applying a foamed or non-foamed dispersion of a polymeric material to a selected portion of the dried electrolyte solution coated knitted glove liner fitted onto a glove mould, by immersion in tank(s) containing the foamed or non-foamed dispersion(s) of polymeric material, with or without applying foamed or non-foamed electrolyte solution(s) with some intermediate stages of gelling, so that the polymeric material penetrates partially through a thickness of the knitted glove liner and for at least a portion of the knitted liner, the polymeric material does not fully penetrate the knitted glove liner;

coating the polymeric material treated area of glove liner fitted onto a glove mould with a foam layer of a solution comprising at least one selected from the group consisting of a surfactant, a tenside and an aerosol;

applying an aqueous or alcoholic solution of an electrolyte;

placing the treated knitted glove liner in a diffusion bath;

heating the treated knitted glove liner, after removal from the diffusion bath, to a temperature to vulcanize or to stabilize the polymeric coating to form a glove comprising a knitted liner adhered to polymer cured coating fitted onto a glove mould;

wherein the knitted glove liner comprises a yarn of a denier in the range of from 100 to 4500, having a plurality of stitches.

### DETAILED DESCRIPTION OF THE PREFERRED EMBODIMENTS

The knitted liner may be prepared from any appropriate flexible material. The choice of material selected will depend the end requirements of the glove and the utility for which the glove is intended. Comfort and designed resistance to cutting, puncturing and abrasion must be considered when selecting the material of construction for the knitted liner.

Any suitable flexible material may be selected as the yarn for the knitted liner and suitable materials include, for example, cotton, polycotton, steel, glass, polyaramid, wool, polyamide, high tenacity polyamide, polyester, polyethylene, ultra high molecular weight polyethylene (UHWPE), bamboo fiber, silver, carbon, copper, spandex, lycra, acrylic, polyvinyl alcohol, hemp, Vectron or combinations of any of these materials. An example of a preferred polyaramid is Kevlar® while fibers sold under the trade name Dyneema® is a preferred UHWPE.

Yarns of these materials may be formed into the fabric of the knitted liner by any method known in textile art. These yarns may be treated with anti-microbial agents and/or Nano-technology methods.

The liner is preferably knitted with large hook needles such as a 15 gauge needle. The denier of the yarn is in the range of from 100 to 4500, preferably 100 to 600 and most preferably 280 to 420. The yarn may be may be passed through a bath of silicone free mineral oil to provide lubricity to the needle latches during the knitting process.

Generally in the knitting of the liner, the stitch density of the glove is set and controlled by adjustment of the stitch control motor. The stitch density at all knuckle joints may be relaxed to allow flexibility for finger movement. At the lower palm the stitch density may be tightened gradually to conform with the shape of a hand. The finger tip portion of the glove may be rounded by electronic control of the knitting process.

The knitted liner is treated with an adequate concentration of non-ionic softener(s) so as to make the surface non-ionic and thus prevent any deleterious effects to the yarn by exposure to the various aqueous media employed throughout the manufacturing process. The treatment may be effected by an exhaust method and a suitable non-ionic softener may be selected by one of ordinary skill in the art in order to obtain a softer, dexterous and flexible coated glove. Shrinkage of the yarn may be checked for suitable flexibility and softness.

The mould which is inserted into the hand shaped knitted liner to form the substrate treatment unit may be constructed of any material suitable for this purpose which is stable to the treatment chemicals and temperatures employed in the process to which the mould is exposed. For purposes of description clarity herein, a mould to which the knitted glove liner is fitted by insertion of the mould into the knitted liner is referred to as the “substrate treatment unit” and may be referred to herein as the “unit” or “treatment unit.”

The initial electrolyte treatment of the treatment unit may be accomplished by dipping the treatment unit into a tank containing a solution of the electrolyte or a solution of the electrolyte may be spray coated onto the treatment unit. Suitable electrolytes include organic acids, for example, formic acid and acetic acid, inorganic acids, alkali metal salts, alkaline earth metal salts and transition metal salts. Combinations of these electrolytes may be used. Preferred electrolytes are acetic acid, formic acid, calcium nitrate and calcium chloride. Most preferred electrolytes are calcium nitrate and acetic acid.

The electrolyte is dissolved in water, an alcohol or an aqueous alcohol mixture. Preferred alcohols are those having 1 to 12 carbons. Preferably alcohols having 1-6 carbons and most preferably alcohols having 1-4 carbon atoms are used. For application to the treatment unit the electrolyte solution may be foamed or non-foamed.

For the purposes of this invention, the electrolyte solution may completely or incompletely penetrate the thickness of the knitted liner. After application of the electrolyte solution to the knitted liner of the treatment unit, the treatment unit is partially dried to remove the solvent, while retaining electrolyte within the penetrated depth of the knitted liner.

The polymeric material applied from the polymeric dispersion may be at least one of natural rubber, synthetic polyisoprene, styrene-butadiene copolymer, acrylonitrile-butadiene copolymer, carboxylated acrylonitrile-butadiene copolymer, polychloroprene, polyacrylate, butyl rubber, polyvinyl chloride, polyvinyl acetate, polyethylene, water-based polyester-based polyurethane, water-based polyether-based polyurethane, cross-linked sodium carboxymethylcellulose and solvent based polyurethane.

The aqueous dispersion of the polymeric material may be foamed or non-foamed. The solids content of the dispersion is in the range from 10 to 70% by weight, preferably 20 to 60% by weight, and most preferably 25 to 45% by weight. The dispersion may be stabilized with vulcanizing agents, for example, sulphur, zinc oxide and metal alkyl carbamates or other stabilizers. The emulsion may contain other ingredients conventionally known in the art and may include surfactants, anti-microbial agents and fillers.

The viscosity of the polymeric dispersion is controlled by adjustment of the solids content, dispersing agents, additives such as thickeners and/or rheology control agents and dispersion medium as known to one skilled in the art and may be in the range of 100 to 20000 centipoise, preferably 250 to 15000 centipoises, and most preferably 500 to 3000 centipoise. The viscosity may be adjusted to assist the control of the depth of penetration of the polymer dispersion into the knitted liner.

The polymeric dispersion may be foamed for application to the glove liner of the treatment unit. In this manner the aqueous dispersion may be blended with air or other gas which does not chemically affect the polymeric material or liner material. Combinations of such gases may be employed. The gas or gases may be mechanically blended with the aqueous dispersion or generated by chemical reaction within the aqueous dispersion. Depending on the sought after level of porosity of the glove the amount of gas foamed into the polymer dispersion may range from 1 to 80% by volume, preferably 5 to 60% by volume and most preferably 8 to 45% by volume.

When the foamed or non-foamed polymeric dispersion is applied to the electrolyte treated glove liner, the dispersion will penetrate the liner to a depth determined by the viscosity of the polymer dispersion, the length of time the treatment unit remains in the dipped state and the concentration of electrolyte at a given depth into the glove liner. As the polymeric dispersion encounters electrolyte upon penetration, it coagulates or gells due to the influence of the electrolyte and deeper penetration is diminished.

Due to the coagulation effect of the electrolyte upon the polymeric dispersion, at least 20% of the interior of the glove liner substrate is not penetrated to the skin contacting surface, preferably at least 50% of the interior is not penetrated to the skin contacting surface, most preferably at least 80% is not penetrated to the skin contacting surface and ultimately preferred, substantially no penetration to the skin contacting surface occurs.

Since with increasing distance of the polymeric material from the surface of the knitted liner the opportunity to encounter electrolyte significantly decreases, the extent of gelling also gradually decreases with distance from the knitted liner so that the outer surface of the polymeric material remains not gelled or only partially gelled.

The surfactant, tenside and/or aerosol may be any such chemicals known to one of skill in the art. Examples include, for example, sodium linear alkyl benzenesulfonates, quaternary ammonium salts, carboxylates, sulfates, betaines, fatty acids and poly glycol ethers. Combinations of these may be employed as determined by one of skill in the art in order to achieve selected and desired effects on the polymer coating.

The surfactant, tenside and/or aerosol solution may be in water or aqueous alcohol mixtures. In the case of aqueous alcohol mixtures, alcohols having 1-12 carbons are used. Preferably alcohols having 1-6 carbons and most preferably alcohols having 1-4 carbon atoms are used. Methanol, ethyl alcohol, propanol and isopropanol are most preferred. The alcohol water composition may be of any water alcohol ratio depending on the surfactant, tenside or aerosol used and the desired effect on the polymeric material.

The foamed surfactant, tenside and/or aerosol solution may contain a soap and a gelling aid such as cellulose or a cellulose derivative. Benzyl alcohol may be added to assist stabilization and to make grooves which can hold gases.

A change in the appearance of the surface of the polymeric coating may be observed during or as a result of the dipping treatment in the diffusion bath.

The second electrolyte treatment of the treatment unit may be accomplished by dipping the treatment unit into a tank containing a solution of the electrolyte. The length of time of the dipping may range from about 1 to about 20 seconds, preferably 1 to 15 seconds and most preferably 1 to 5 seconds.

Suitable electrolytes include organic acids, for example, formic acid and acetic acid, inorganic acids, alkali metal salts, alkaline earth metal salts and transition metal salts. Combinations of these electrolytes may be used. Preferred electrolytes are acetic acid, formic acid, calcium nitrate and calcium chloride.

The electrolyte is dissolved in water, an alcohol or an aqueous alcohol mixture. Preferred alcohols are those having 1 to 12 carbons. Preferably alcohols having 1-6 carbons and most preferably alcohols having 1-4 carbon atoms are used. For application to the treatment unit the electrolyte solution may be foamed or non-foamed. Foaming may be accomplished as described above.

Although not limited by any expressed theory, the advantage of the present invention is realized in the sequential and combined treatments described in the claims. A physical and/or chemical reaction occurs in the diffusion bath and can be observed at the interface. As a result of this reaction, fine cavities and pores are created in the polymeric coating. The formed pores may extend the entire depth of the polymer coating and provide for the breathability of the glove when construction is complete. The cavities formed on the surface of the polymeric coating provide good grip even in slippery environments such as water, oil or grease.

The obtained polymeric coating on the glove liner substrate may range from about 0.05 mm to 5.5 mm in thickness depending on the desired degree of protection and flexibility. A preferred range of thickness is 0.25 mm to 4.0 mm and a most preferred range is 0.30 to 3.7 mm. The cavities and pores formed in and on the coating are randomly, but uniformly distributed on the surface and throughout the depth of the coating. A large range of cavity and pore density in the polymeric coating is possible depending on the concentration of the salts in the electrolyte solution and the post treatments in the diffusion bath or surfactant solution and the concentration, length of treatment and treatment temperature of the electrolyte overcoating.

The treatment conditions described in the previous paragraph may be varied and controlled to achieve a desired coating morphology by one of skill in the art. According to the claimed invention gloves capable of absorbing one milliliter of water in a range of from about 1 second to about 300 seconds, preferably 1 second to about 250 seconds and most preferably 1 second to about 120 seconds, may be produced. The same gloves are capable of absorbing one milliliter of oil in a range of from about 5 seconds to 500 seconds, preferably 50 seconds to 450 seconds and most preferably 250 seconds to 400 seconds.

Following the electrolyte treatment the treatment units may be hung horizontally or vertically to allow drainage of the liquid treatment solutions. The unit may then be placed in a diffusion bath for one to thirty minutes in order to remove water-soluble residuals. Such residuals may include electrolytes, surfactants and other additives used to promote the formation of the coating morphology. Finally, the treatment unit is placed in a heated environment at a temperature of from 80 to 140° C., preferably 90 to 130° C., and most preferably 100 to 120° C., to fully cure the polymer coating.

The glove liner substrate and applied cured polymeric coating is then removed from the mould to obtain a semi-finished glove, which is washed in an alcoholic bath and/or an aqueous bath. The washed semi-finished glove is coated with a fluorochemical composite dispersion according to conventional methods known to one of skill in the art.

TABLE 1

| | | Dry | Dry | Wet | Wet | Oil | Oil | | |
|---|---|---|---|---|---|---|---|---|---|
| | | Grip | Grip | Grip | Grip | Grip | Grip | | |
| | | Metal | Glass | Metal | Glass | Metal | Glass | Water | Oil |
| Sample | Glove | Rod | Rod | Rod | Rod | Rod | Rod | Permeability | Permeability |
| 1 | NINJA-X* | ***** | ***** | **** | * | *** | ** | 15 sec/ml | 135 sec/ml |
| 2 | TOP FLEX* | ***** | ***** | **** | * | *** | ** | 15 sec/ml | 150 sec/ml |
| 3 | NITRISPONGE* | ***** | ***** | * | Nil | * | * | 4 minutes | Didn't pass |
| | | | | | | | | Slight | through |
| | | | | | | | | wetting | |
| 4 | NITRILON* | **** | **** | *** | Nil | ** | *** | 15 sec/ml | 360 sec/ml |
| | FLEX* | | | | | | | | |
| 5 | NITRILON* | ***** | ***** | Nil | Nil | Nil | Nil | Didn't pass | Didn't pass |
| | | | | | | | | through | through |
| 6 | NTF Coating | ***** | ***** | **** | ** | *** | ** | 11 sec/ml | 104 sec/ml |
| | (Invention) | | | | | | | | |
| 7 | MAXI FLEX** | *** | *** | ***** | Nil | Nil | **** | Didn't pass | Didn't pass |
| | | | | | | | | through | through |
| 8 | HyFlex ®** * | ***** | **** | ** | Nil | * | Nil | 840 sec/ml | Didn't pass |
| | 11-920 | | | | | | | | through |

*MIDAS SAFETY INC.
**JOHN WARD CEYLON (PVT) LTD.
***ANSELL

The ratings indicated in Table 1 for grip testing are qualitative and are based on an assessment wherein an individual wearing the glove to be tested, gripped a portion of a one inch diameter test rod which had been dipped in the test medium (water or oil). A second individual, holding a clean portion of the rod, then pulled the rod from the grip held by the glove. The individual who held the rod in the test glove assigned a number represented by the number of “*'s” in the Table, which correlated with the amount of gripping effort required to hold the rod. The higher number of “*”, the greater the grip afforded by the glove as assessed by the individual who held the rod in the test glove.

The permeability test was performed by holding a test portion of a glove horizontally and placing one milliliter of the test liquid (water or oil) on the outer surface of the glove. The amount of time required for the liquid to seep from the outer surface side to the inner surface was recorded.

As shown by the data in Table 1, the gloves according to the claimed invention provide overall better grip capability for a metal or glass rod coated with water or oil while simultaneously providing good permeability in comparison with conventional commercial similar style work gloves.

While the invention has been described by the specific embodiments, it is evident that alternatives, modifications and variations thereof, within the scope of the claimed invention, will be apparent to those skilled in the art. The embodiments are exemplary and should not be interpreted to be limiting in scope. Accordingly, all alternatives, modifications and variations which are within the scope of the appended claims are embraced herein.

1. A method for preparing a flexible, liquid absorbent coated glove, comprising:
treating a knitted glove liner fitted onto a glove mould with a nonionic softener;
coating the treated knitted glove liner fitted onto a glove mould, with a foamed or non-foamed electrolyte solution;
drying the coated glove liner fitted onto a glove mould;
applying a foamed or non-foamed dispersion of a polymeric material to a selected portion of the dried electrolyte solution coated knitted glove liner fitted onto a glove mould, by immersion in tank(s) containing the foamed or non-foamed dispersion(s) of polymeric material, with or without applying foamed or non-foamed electrolyte solution(s) with some intermediate stages of gelling, so that the polymeric material penetrates partially through a thickness of the knitted glove liner and for at least a portion of the knitted liner, the polymeric material does not fully penetrate the knitted glove liner;
coating the polymeric material treated area of glove liner fitted onto a glove mould with a foam layer of a solution comprising at least one selected from the group consisting of a surfactant, a tenside and an aerosol, by immersion in a tank containing the surfactant, tenside and/or aerosol foamed solution;
applying an aqueous or alcoholic solution of an electrolyte to obtain a treated knitted glove liner;
placing the treated knitted glove liner in a diffusion bath;
heating the treated knitted glove liner, after removal from the diffusion bath, to a temperature to vulcanize or to stabilize the polymeric coating to form a glove comprising a knitted liner adhered to polymer cured coating fitted onto a glove mould;
wherein the knitted glove liner comprises a yarn of a denier in the range of from 100 to 4500, having a plurality of stitches.

2. The method according to claim 1, further comprising:
applying to an outer surface of the glove comprising a knitted liner adhered to polymer cured coating, fitted onto a glove mould, a fluorochemical composite dispersion; and
heating to dry and cure the applied fluorochemical composite dispersion.

3. The method according to claim 1, wherein the yarn of the knitted glove liner is a natural or synthetic yarn or a combination thereof.

4. The method according to claim 1, wherein the yarn of the knitted glove liner comprises at least one selected from the group consisting of cotton, polycotton, steel, glass, polyaramid, wool, polyamide, polyester, polyethylene, UHMWPE, Bamboo fiber, silver fiber, carbon fiber, copper fiber, spandex, lycra, acrylic, High tenacity Polyamide, PVA, Hemp and Vectron.

5. The method according to claim 1, wherein the polymeric material of the applied dispersion is one selected from the group consisting of natural rubber, synthetic polyisoprene, Styrene-butadiene copolymer, carboxylated or non-carboxylated acrylonitrile-butadiene copolymer, polychloroprene, polyacrylate, butyl rubber, polyvinyl chloride, Polyvinylacetate, Polyethylene, polyester, polyurethane, polyether, sodium carboxymethylcellulose and combinations thereof.

6. The method according to claim 1, wherein a solids content of the dispersion of polymeric material is in the range from 10 to 70% by weight.

7. The method according to claim 1, wherein a viscosity of the dispersion of a polymeric material is in a range of from 200 to 4000 centipoise.

8. The method according to claim 1, wherein the surfactant, tenside and aerosol is at least one selected from the group consisting of a sodium linear alkyl benzenesulfonate, a quaternary ammonium salt, a carboxylate, a sulfate, a betaine, a fatty acid and a polyglycol ether.

9. The method according to claim 1, wherein fine pores and cavities are formed in the polymeric coating of the substrate glove liner by a chemical and/or physical reaction due to interaction of the electrolyte solution with the polymeric material coated with the foam layer of a solution comprising at least one selected from the group consisting of a surfactant, a tenside and an aerosol.

10. The method according to claim 1, wherein the polymeric coating applied to the substrate glove liner ranges from about 0.05 mm to 5.5 mm in thickness.

11. The method according to claim 1, wherein the dispersion of polymeric material is foamed.

12. The method according to claim 11, further comprising:
applying to an outer surface of the glove comprising a knitted liner adhered to polymer cured coating, fitted onto a glove mould, a fluorochemical composite dispersion; and
heating to dry and cure the applied fluorochemical composite dispersion.

13. The method according to claim 11, wherein the yarn of the knitted glove liner is a natural or synthetic yarn or a combination thereof.

14. The method according to claim 11, wherein the yarn of the knitted glove liner comprises at least one selected from the group consisting of cotton, polycotton, steel, glass, polyaramid, wool, polyamide, polyester, polyethylene, UHMWPE, Bamboo fiber, silver fiber, carbon fiber, copper fiber, spandex, lycra, acrylic, High tenacity Polyamide, PVA, Hemp and Vectron.

15. The method according to claim 11, wherein the polymeric material of the applied foamed dispersion is one selected from the group consisting of natural rubber, synthetic polyisoprene, Styrene-butadiene copolymer, carboxylated or non-carboxylated acrylonitrile-butadiene copolymer, polychloroprene, polyacrylate, butyl rubber, polyvinyl chloride, Polyvinylacetate, Polyethylene, polyester, polyurethane, polyether, sodium carboxymethylcellulose and combinations thereof.

16. The method according to claim 11, wherein a solids content of the foamed dispersion of polymeric material is in the range from 10 to 70% by weight.

17. The method according to claim 11, wherein a gas content of the foamed polymeric dispersion is in the range from 1 to 45% by volume.

18. The method according to claim 11, wherein a gas content of the foamed polymeric dispersion is in the range from greater than 45 to 80% by volume.

19. The method according to claim 11, wherein a viscosity of the dispersion of a polymeric material is in a range of from 200 to 4000 centipoise.

20. The method according to claim 11, wherein the surfactant, tenside and aerosol is at least one selected from the group consisting of a sodium linear alkyl benzenesulfonate, a quaternary ammonium salt, a carboxylate, a sulfate, a betaine, a fatty acid and a polyglycol ether.

21. The method according to claim 11, wherein fine pores and cavities are formed in the polymeric coating of the substrate glove liner by a chemical and/or physical reaction due to interaction of the electrolyte solution with the polymeric material coated with the foam layer of a solution comprising at least one selected from the group consisting of a surfactant, a tenside and an aerosol.

22. The method according to claim 12, wherein the polymeric coating applied to the substrate glove liner ranges from about 0.05 mm to 5.5 mm in thickness.
